(19) United States
(12) Patent Application Publication
(10) Pub. No.: US 2009/0029721 A1
(43) Pub. Date: Jan. 29, 2009

(54) Method And System For Delivering Customized Advertisements To Mobile Devices

(76) Inventor: Naganand Doraswamy, Bangalore (IN)

Correspondence Address: Ashok Tankha, 36 Greenleigh Drive, Sewell, NJ, 08080, US

(21) Appl. No.: 12/145,507

(22) Filed: Jun. 25, 2008

(30) Foreign Application Priority Data
Jul. 25, 2007 (IN) 1603/CHE/2007

(51) Int. Cl. H04Q 7/20

(52) U.S. Cl. 455/456.3

(57) ABSTRACT

Disclosed herein is a method and system for delivering advertisements asynchronously to a user of a mobile device. The delivery of the advertisements is based on a number of preferences and delivery parameters. The transferred advertisements are stored on local drives of the mobile device. A client application on the mobile device intelligently determines the state of use of the mobile device and delivers advertisements depending on the state of use of the mobile device. The rendering of advertisement is performed in a controlled and non-intrusive manner, independent of the wireless network used by the mobile device. The advertisements are customized based on the user's geographic location, preferences, interests, etc.

### CROSS REFERENCE TO RELATED APPLICATIONS

This application claims the benefit of the Indian patent application 1603/CHE/2007 titled “Method And System For Delivering Customized Advertisements To Mobile Devices” filed on Jul. 25, 2007 in the Indian Patent Office.

### BACKGROUND

This invention, in general, relates to delivery of advertisements to handheld devices and more specifically relates to delivery of advertisements to mobile devices in a non-intrusive manner.

One way in which advertisements are currently delivered to mobile devices is via text messages using short messaging service (SMS). Such SMS advertisements are usually intrusive and may interfere with the mobile device's usage. Since these short messages may be ill-timed and interfere with regular communication, the messages are often considered as spam by mobile device users. In general, unsolicited short messages are not appreciated by users.

Advertisements delivered as text SMS messages may not provide a rich user experience as the text messages have no rich media capability. Hence, advertisements limited to SMS messages would not be an effective and efficient way to draw the user's attention. Further, existing methods provide limited scope for customization of advertisement delivery. The customization is usually based on various parameters influenced by the end users, advertisers or network operators. Moreover, there is need for customization of advertisements for both the advertiser and the end user in order to meet each other's requirements and demands.

The current arts of advertisement delivery may employ banner advertisements to mobile devices through banner advertisements. The banner advertisements are displayed on the mobile device when a user browses a web site from the mobile device. Such banner advertisements are similar to any web-based online advertising. Although a banner advertisement is less intrusive than advertisements delivered through SMS, banner advertisements still intrude on the web browsing activity.

Hence, there is a need for a method and system that strikes a balance between user's preference, schedule and advertisers' benefits and requirements while delivering advertisements in a customized and non-intrusive manner.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above mentioned need for efficient delivery of rich media advertisements to a mobile device. The method and system herein considers users' preferences and advertisers' benefits and requirements for selectively delivering advertisements on mobile devices in a customized and non-intrusive process. The method and system disclosed herein incorporates an asynchronous transfer of advertisements to mobile devices. The delivered advertisements can be customized based on a number delivery parameters and preferences of both the users and the advertisers. The transferred advertisements are stored locally in the mobile device. A client application on the mobile device intelligently determines the state of use of the mobile device and delivers advertisements depending on this state. The advertisements are rendered in a controlled and non-intrusive manner. Furthermore, advertisement delivery is independent of the underlying wireless network, and may concurrently support users served by different network operators.

The advertisements may be customized based on a user's geographic location, preferences and interests. In one embodiment of the method and system disclosed herein, an “on-demand pull” method may be employed in which a client application executing in the mobile device initiates advertisement transfers based on requests from the user. In another embodiment, a “periodic pull” method may be employed in which a client application executing in the mobile device periodically contacts an advertisement center to download new advertisements. In yet another embodiment, a “push” method is employed in which an advertisement center proactively initiates advertisement transfer to mobile devices with delivery parameters set by advertisers.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings; however, the invention is not limited to the specific methods and instrumentalities disclosed.

FIG. 1 illustrates a method of delivering advertisements non intrusively to mobile devices.

FIG. 2 illustrates a system for delivering advertisements non intrusively to mobile devices.

### DETAILED DESCRIPTION OF THE INVENTION

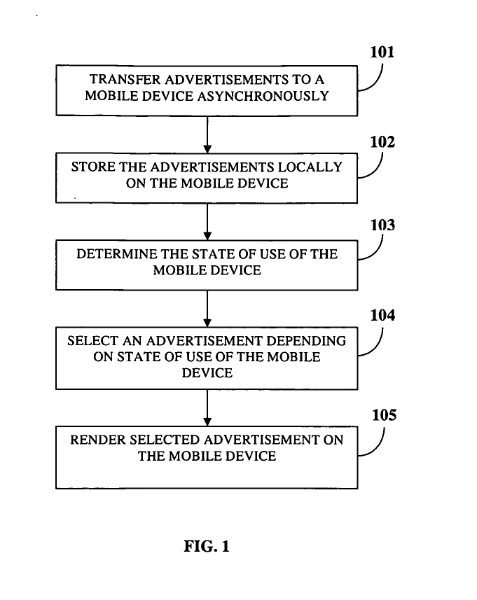

FIG. 1 illustrates a method of delivering advertisements non intrusively to a user of a mobile device 206. The advertisements from various advertisers 208 are asynchronously transferred 101 through an advertisement center 201 to a mobile device 206. The asynchronous transfer of advertisements is based on different parameters such as network traffic, time criticality of the advertisements, state of use of the mobile device 206, etc., and does not require the user's intervention. The transferred advertisements are stored 102 locally in the mobile device 206 for later rendering of the advertisements in a non-intrusive manner. The state of use of the mobile device 206 is monitored in order to determine 103 the right state to render each of the stored advertisements. Depending upon the state of use of the mobile device 206, an advertisement is selected 104 from the stored advertisements. The selected advertisement is rendered 105 on the mobile device 206 such that the rendered advertisement does not interfere with regular communication and is appropriate to suit the mobile device's 206 use state. For example, an advertisement may be displayed on the device's screen as background when the mobile device 206 is idle. The duration of advertisement display can be tailored, so that the advertisements are displayed on the mobile device 206 for a predetermined duration. The advertisement may be rendered in one or more modes of text, audio, graphics, animation, video, and interactive modes.

Also, by maintaining an inventory of advertisements stored locally in the phone, the advertisements can be cycled. Furthermore, advertisements can be displayed just prior to and after a communication activity by the user, thereby ensuring that the advertisements displayed will be seen by the user. The determination of the state of use of the mobile device 206, and the non-intrusive rendering of advertisements, is performed by an intelligent client application 206a present on the mobile device 206. The client application 206a may be downloaded wirelessly from an advertisement center 201. The advertisement center 201 is responsible for coordinating the transfer of advertisements to the mobile device 206. The advertisement center 201 is in constant communication with advertisement databases 202. The advertisers 208 dynamically upload new advertisements or dynamically alter an uploaded advertisement on the advertisement databases 202. Further, these advertisements are dynamically uploaded from the advertisement source database to the advertisement center 201. Various advertisers 208 access the advertisement center 201 through a well-defined protocol interface 207 such as the web services interface.

The advertisements to be delivered to the mobile device 206 are selected based on a number of preferences and delivery parameters. These preferences comprise the mobile device user preferences and advertisers' 208 preferences. The mobile device user preferences further comprise interests of a user, requests of the user for advertisements on specific products and services, etc. In one embodiment of advertisement delivery, an “on-demand pull” method is employed in which the client application 206a initiates advertisement transfers based on requests from the user. For instance, the mobile device user may search for a specific product or service on the mobile device 206. The client application 206a requests the advertisement center 201 for advertisements that are relevant to the context of the user's search. An advertisement center 201 logic searches for suitable advertisements in the advertisement databases 202. The advertisements transferred to the mobile device 206 in response to the search query may be selected based on the advertisement relevance to the search query, user location, priority, revenue models, etc.

The advertisers' 208 preferences comprise targeted user profiles, targeted geographical locations, periodicity and time of advertisement delivery, and duration of advertisement display. The intelligence in the client application 206a observes users' calling patterns and feature usage and thereafter characterizes users into different demographics. Examples of calling patterns and feature usage include patterns of incoming versus outgoing calls, number of local and long distance calls, duration of calls, number of short messages and multimedia messages sent or received, usage of value added services, etc. Thus, using the information on calling patterns, users may be classified into different categories such as “high-value, high-spending”, “younger generation”, “mature user”, “business user”, “economy or budget-constrained user”, etc., and deliver user category-specific advertisements. The demographic information of the user may also be obtained statically by querying the subscriber information available in the network operator's database. Some of the advertisements delivered may have embedded web links or phone numbers, and user profiles may be further characterized based on user actions on these web links or phone numbers.

In another embodiment of advertisement delivery, a “periodic pull” method is employed in which the client application 206a periodically contacts the advertisement center 201 to download new advertisements. During any “pull” or any “push” contact, the client application 206a transmits information about the user location to the advertisement center 201, as obtained from cell information broadcasts, or through global positioning system (GPS) and other techniques of location determination. In addition, the client application 206a may transmit other information such as user preferences, the periodicity of delivery of advertisements, the amount of display time of specific advertisements since the last download, static parameters such as the characteristics of the device, dynamic parameters such as location, remaining memory and battery power, etc. The advertisement center 201 logic dynamically selects and prioritizes the advertisements to be transferred to the mobile device 206, using criteria such as subscriptions by the advertisers 208, user preferences, information on user location and other customization parameters. The advertisement center 201 then instructs the client application 206a on the format and display of advertisements, delivery parameters such as the periodicity of advertisement display or delivery, lifetime of advertisements, etc., and notifies subsequent “periodic pull” schedules. The advertisement center 201 logic thus controls advertisement selection and delivery for each user and may change the displayed advertisements dynamically in response to user's preferences. The advertisement center 201 additionally collects statistics delivered by the client application 206a and uses these statistics for customized delivery of advertisements and accounting purposes.

In another embodiment of advertisement delivery, a “push” method is employed in which the advertisement center 201 proactively initiates advertisement transfer to the mobile device 206 based on delivery parameters set by advertisers 208 or human initiated events. While the “periodic pull” and “on-demand pull” methods require the client application 206a to connect to the advertisement center 201 periodically or on-demand, the “push” method requires the client application 206a to maintain a constant connection with the advertisement center 201. In another embodiment of the “push” mechanism, a “scheduled push” mechanism is employed in which a client application 206a is instructed to contact the advertisement center 201 at specific times to check for new advertisements. The “scheduled push” mechanism can be customized to deliver advertisements based on days of a year, or other parameters. For example, during holidays when mass advertisements are expected, the recurrence of “scheduled push” may be increased.

A revenue payment model may be incorporated, whereby a share of the revenue generated from the advertisers 208 is distributed amongst the users and the mobile operators. The user of a mobile device 206 may receive incentives for downloading the client application 206a. The incentives may be in the form of discounts on bill amounts, gift vouchers, etc. The mobile network operator may receive a share in the collected revenue for permitting advertisement delivery on the operator's wireless network.

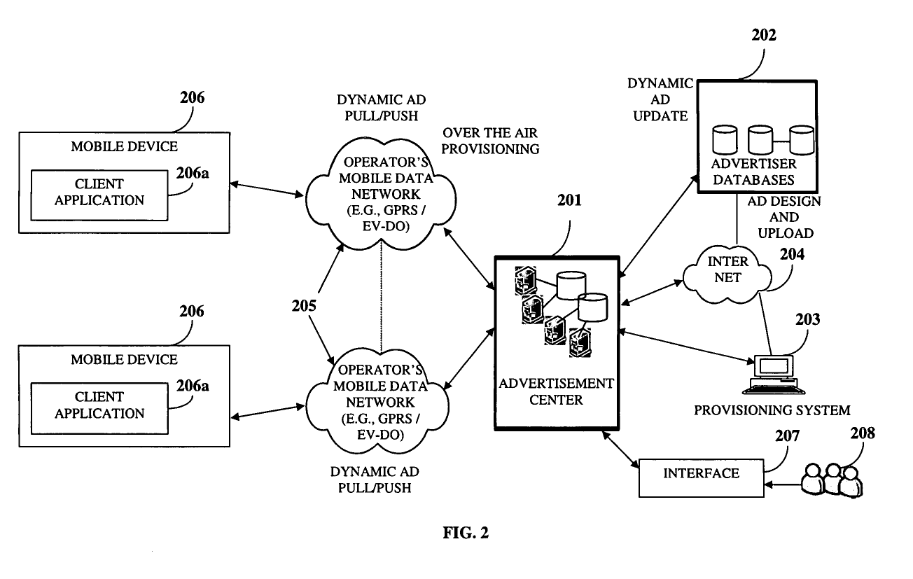

FIG. 2 illustrates a system for delivering advertisements non intrusively to a user of a mobile device 206. The system disclosed herein comprises a client application 206a on the mobile device 206, an advertisement center 201, advertisement databases 202, and a provisioning system 203 connected via a network 205. The advertisement center 201 coordinates the transfer of advertisements. The advertisement center 201 may operate independent of the underlying wireless network 205, i.e., the advertisement center 201 concurrently supports all users irrespective of the network operators the users subscribe to. The advertisement center 201 further comprises a set of servers and logic to store and deliver the advertisements over multiple mobile networks to the mobile device 206. The intelligence of the advertisement center 201 customizes the advertisements based on user's geographic location, user's interest and time of day. When a user subscribes to the advertisement delivery service, the client application 206a is downloaded over the air and installed onto the mobile device 206. The client application 206a may be customized for different mobile devices. Once the client application 206a is installed in a mobile device 206, it registers the mobile device user with the advertisement center 201. The advertisement center logic creates a profile for the user. In compliance with the policies set by the corresponding network operator, the logic of the advertisement center 201 may determine the advertisement delivery methodology. The user profile created by the advertisement center logic may store information such as user's interests, preferences, etc. The information in the user's profile is used for customizing the advertisements to be delivered to the user. A server in the advertisement center 201 remotely controls the manner in which advertisements are displayed on the mobile device 206. For example, the duration of display and periodicity of advertisement delivery can be set as parameters in downloaded advertisements based on the monetary value of the advertisements. These parameters are interpreted by the intelligence in the client application 206a to display advertisements with the desired periodicity and duration.

For an efficient rendering of the advertisement, the advertisement formats are selected based on the mobile device characteristics such as the type of display used, the graphic features supported by the mobile device 206, etc., and the network channel bandwidth. For accounting purposes, the advertisement center 201 keeps track of the advertisements delivered and associated customer details. Logic in the advertisement center 201 implements both “push” and “pull” contact methods whereby the ads are delivered proactively or in response to user requests. The “push” method may be influenced by delivery policies of both advertisers 208 and mobile network operators.

The advertisement center 201 supports wireless provisioning of the client application 206a upon request from a user, and automatically updates the client application 206a and associated data such as download policies. The advertisement center 201 implements a well-defined protocol interface 207, for example, a web services interface to access mobile operator facilities for identifying mobile device users from mobile operator's databases. The web services interface is further used for subscription of the delivery services by the advertisers 208. The advertisers 208 may upload their advertisements through the interface 207.

The intelligence in the advertisement center 201 queues new advertisements that are to be transferred to the mobile device 206 and predetermines the transfer schedules of these advertisements. Transfers may be scheduled when network usage is light, for example during non-peak times. The client application 206a in the mobile device 206 may decide the number of advertisements to be transferred per schedule depending on the memory status on the mobile device 206, or may communicate the memory status to the advertisement center 201.

The advertisement databases 202 comprise a distributed set of databases that may be maintained by various advertising entities or sources interested in advertising through the mobile device 206. Some examples of such advertising entities include but are not restricted to media, product and service companies. The advertisement databases 202 contain advertisements formatted for the mobile communication media. The advertisement databases 202 updates the advertisement center 201 dynamically based on source user's subscription to the delivery service.

The client application 206a provided on the user's mobile device 206 connects to the advertisement center 201 for downloading and delivering advertisements, updating the advertisement center 201 about the mobile device location, receiving schedules of advertisement delivery from the advertisement center 201 and indicating user requests to the advertisement center 201. The client application 206a of the mobile device 206 prioritizes the set of locally stored advertisements for display at any given point in time. The client application 206a further facilitates non-intrusive display of advertisements. The client application 206a on the user's mobile device 206 implements the intelligence for asynchronous “pull” and “push” delivery methods. The client application 206a records information such as the statistics of advertisement viewing, the actions performed on the mobile device 206 by the user, etc., and uploads the information to the advertisement center 201. The intelligence of the client application 206a manages the methods of advertisement display, advertisement delivery and determines the time of delivery. The policies that govern the behavior of the client application 206a may be automatically downloaded and dynamically updated. The client application 206a further allows the user to express preferences on the products or services of interest and explicitly search for specific product or service on demand. The operator's mobile data network 205 such as those based on the well-known general packet radio service (GPRS), universal mobile telecommunications system (UMTS), and evolution-data optimized (EV-DO) technologies, comprise facilities for internet protocol (IP) based communication between the client application 206a of the mobile device 206 and the advertisement center 201.

The client application 206a in a mobile device 206 may determine the geographic location of the mobile device 206 from mobile device information broadcasts. The client application 206a combines the cell information broadcasts that usually encode local information with the home/roaming information to determine the region where the mobile device 206 is being operated. The geographical location of certain mobile devices enabled with global positioning system (GPS), may be determined by the GPS technology. In such mobile devices, the GPS receiver on the mobile devices receive signals from a global navigation satellite system (GNSS). The signals are decoded to determine the GPS receiver's location.

The provisioning system 203 comprises customized software that allows advertisers 208 and mobile network operators to subscribe and manage the delivery service. The provisioning system 203 further allows advertisers 208 to subscribe to the delivery service, specify the parameters and policies regarding delivery, specify advertisement databases 202 and access methods, establish payment methods, and establish a control point for managing the subscription and delivery of advertisements. The provisioning system 203 assists mobile network operators to specify network access methods, and delivery parameters such as time-of-day and maximum permissible bandwidth usage. The provisioning system 203 may be connected to the advertisement center 201 and the advertisement databases 202 via the internet 204.

In one embodiment, the advertisements may be displayed as wall papers when the phone display lights up during a new call and for a customized period of time after a user completes a call. Such advertisements may incorporate a “click to call” phone numbers which the user can select to make a phone call to the advertising entity or the entity's agent. Such advertisements could also incorporate a “click to message” feature, whereby the user can select an email address or SMS code to send a text message to the advertising entity or agent. The client application 206a allows the user to search for specific product or service in the user's location or elsewhere when the user desires.

A subscription model for the advertisers 208 may comprise a one time transfer to a set of end users fitting a particular profile, for example, users in a certain geographic area or for delivery on a sustained basis. The advertisements from a given source can change dynamically, and the logic in the advertisement center 201 allows advertisements to be uploaded dynamically based on various factors such as calendar, time-of-day, event-triggered, or based on operator command, etc.

It will be readily apparent to those skilled in the art that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A processor means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product, comprising computer executable instructions embodied in a computer-readable medium, comprises computer parsable codes for the implementation of the processes of various embodiments.

Where databases are described, such as advertisement databases 202, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as those described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of delivering advertisements of advertisers non intrusively to a user of a mobile device, comprising the steps of:
transferring said advertisements asynchronously to said mobile device, wherein said transferred advertisements are selected based on a set of preferences and delivery parameters;
storing the transferred advertisements locally on the mobile device;
determining state of use of the mobile device;
selecting an advertisement depending on said state of use of the mobile device; and
rendering said selected advertisement on the mobile device.

2. The method of claim 1, wherein said preferences comprise mobile device user preferences and preferences of said advertisers.

3. The method of claim 2, wherein said user preferences comprise choices and advertisement requests of the user for specific products and services.

4. The method of claim 3, wherein the advertisements delivered on said requests of the user are based on advertisement relevance, user location, priorities set on advertisements, and revenue models.

5. The method of claim 2, wherein said preferences of the advertisers comprise targeted user profiles, targeted geographical locations, and periodicity of advertisement delivery and rendering.

6. The method of claim 1, wherein the advertisements to be delivered are dynamically uploaded to an advertisement center from an advertisement database, wherein said uploading is based on time of day, event triggers, and command of the network operator.

7. The method of claim 1, wherein said delivery parameters comprise network data channel bandwidths, mobile device characteristics, network operator policies, delivery policies specified by said advertisers and pre specified schedules based on usage of network for asynchronous transfer of advertisements.

8. The method of claim 1, wherein the selected advertisement is rendered in one or more modes of text, audio, graphics, animation, video, and interactive modes.

9. The method of claim 1, wherein a subscription model for said advertisement transferring comprises a one time transfer to a set of users fitting a particular profile or a delivery on a sustained basis.

10. A system for delivering advertisements of advertisers non intrusively to a user of a mobile device, comprising:
an advertisement center for coordinating transfer of said advertisements, wherein said advertisement center is independent of the underlying network;
advertisement databases for dynamically updating said advertisement center;
a client application loaded on said mobile device for coordinating delivery of the advertisements on the mobile device based on instructions from the advertisement center; and
a provisioning system for allowing network operators and said advertisers to subscribe and manage the advertisement center.

11. The system of claim 10, wherein said provisioning system enables said network operators and the advertisers to specify delivery policies, specify advertisement said databases, specify access methods to the advertisers, establish payment modes, and establish a control point for managing subscription and delivery.

12. The system of claim 10, wherein said client application is downloaded wirelessly from the advertisement center.

13. The system of claim 10, wherein said client application connects to the advertisement center for downloading and delivering the advertisements, updating mobile device location to the advertisement center, receiving schedules of advertisement delivery from the advertisement center, and indicating user requests to the advertisement center.

14. The system of claim 10, wherein the advertisement center comprises a set of servers and logic for delivering the advertisements over multiple mobile networks to the mobile device.

15. The system of claim 10, wherein the advertisement center keeps track of the advertisements delivered and associated user details for accounting purposes.

16. The system of claim 10, wherein said client application uses mobile device information broadcasts to determine geographic location of the mobile device.

17. The system of claim 10, further comprising an interface between the advertisement center and the advertisers, wherein said interface is a web services interface.

18. A computer program product comprising computer executable instructions embodied in a computer-readable medium, said computer program product including:
a first computer parsable program code for asynchronously transferring advertisements to a mobile device, wherein said transferred advertisements are selected based on a number of preferences and delivery parameters;
a second computer parsable program code for storing the transferred advertisements on local drives of said mobile device;
a third computer parsable program code for determining state of use of the mobile devices; and
a fourth computer parsable program code for delivering said advertisements depending on said state of use of the mobile device.

19. The computer program product of claim 18, further comprising a fifth computer parsable program code for determining geographic location of the mobile device.
